(19) United States
(12) Patent Application Publication
(10) Pub. No.: US 2014/0103060 A1
(43) Pub. Date: Apr. 17, 2014

(54) BOX FOR DISPENSING BLISTER-PACKAGED DRUG

(71) Applicant: JVM CO., LTD., Daegu (KR)

(72) Inventor: Jun Ho KIM, Daegu (KR)

(73) Assignee: JVM CO., LTD., Daegu (KR)

(21) Appl. No.: 14/046,636

(22) Filed: Oct. 4, 2013

(30) Foreign Application Priority Data
Oct. 17, 2012 (KR) 10-2012-0115447
Nov. 2, 2012 (KR) 10-2012-0123536
Nov. 2, 2012 (KR) 10-2012-0123537
Nov. 2, 2012 (KR) 10-2012-0123538

(51) Int. Cl. G07F 11/42

(52) U.S. Cl. CPC G07F 11/42
USPC 221/76

(57) ABSTRACT

Provided is a box for dispensing blister-packaged drugs. The box for dispensing blister-packaged drugs includes a drug accommodation unit having an accommodation space in which the plurality of blister-packaged drugs are separately accommodated, the drug accommodation unit being disposed in at least one row, a position moving unit coupled to the drug accommodation unit to move a position of the drug accommodation unit, and a dispensing unit disposed in the movement direction of the drug accommodation unit to dispense the blister-packaged drugs accommodated in the drug accommodation unit one by one to the outside.

### CROSS-REFERENCE TO RELATED PATENT APPLICATION

This application claims the benefit of Korean Patent Application No. 10-2012-0115447 filed on Oct. 17, 2012 and 10-2012-0123536, 10-2012-0123537, 10-2012-0123538 filed on Nov. 2, 2012 in the Korean Intellectual Property Office, the disclosure of which is incorporated herein in its entirety by reference.

### BACKGROUND OF THE INVENTION

1. Field of the Invention

The present invention relates to a box for dispensing blister-packaged drugs, and more particularly, to a box for dispensing blister-packaged drugs, which is capable of improving accuracy in dispensation of drugs and maximizing drug dispensing efficiency when the blister-packaged drugs are dispensed.

2. Description of the Related Art

In general, various kinds and types of drugs may be included in a dose of drug according to a patient's medical prescription. The dose of drug may be contained in a basket and transferred to a patient.

Various drugs contained in one basket may be collected into the one basket from boxes in which the respective drugs are contained according to the kind and number of drugs written on patient's medical prescription. Then, the basket in which the drugs are collected may be transferred to a patient, and thus, the patient may take the drugs collected in the basket.

In conventional ways, to collect various drugs into one basket, medical experts such as pharmacists may manually select drugs according to a patient's medical prescription to contact the selected drugs into the basket. Thus, it may be necessary to determine accuracy in the collection of the drugs again.

There is possibility of occurrence of drug misadventure because it is difficult to secure accuracy in administration. Also, it takes a long time to collect drugs according to the patient's medical prescription because the collection process is complicated to deteriorate working efficiency in addition to the possibility of the occurrence of the drug misadventure.

Thus, studies with respect to methods and technologies for improving accuracy and efficiency in the collection of drugs for each unit dose according to the patient's medical prescription to provide convenience of uses such as pharmacists and previously prevent drug misadventure from occurring are needed.

### SUMMARY OF THE INVENTION

The present invention provides a box for dispensing blister-packaged drugs, which accurately dispenses blister-packed drugs according to a patient's medical prescription to improve accuracy in drug dispensing and work efficiency.

The technical objects of the present invention are not limited to those described above, and it will be apparent to those of ordinary skill in the art from the following description that the present invention includes other technical objects not specifically mentioned herein.

According to an aspect of the present invention, there is provided a box for dispensing blister-packaged drugs, the box including: a drug accommodation unit having an accommodation space in which the plurality of blister-packaged drugs are separately accommodated, the drug accommodation unit being disposed in at least one row; a position moving unit coupled to the drug accommodation unit to move a position of the drug accommodation unit; and a dispensing unit disposed in the movement direction of the drug accommodation unit to dispense the blister-packaged drugs accommodated in the drug accommodation unit one by one to the outside.

The drug accommodation unit may be disposed in at least two rows, and the drug accommodation units may be symmetrically disposed with respect to a boundary of each of the rows in the rows adjacent to each other to dispense the blister-packaged drugs into the dispensing unit at the same time.

The dispensing unit may include a storage part temporally storing the blister-packaged drugs dispensed at the same time from the drug accommodation units constituting the at least two rows and a switching part dispensing the blister-packaged drugs one by one from the storage part to the outside.

The dispensing unit may correspond to the drug accommodation unit constituting each row, and the switching part may block the storage part except for the storage part corresponding the drug accommodation unit constituting one row from the outside.

When the blister-packaged drugs are dispensed to the outside from the storage part that is not blocked, the switching part may allow one of the blocked storage parts to communicate with the outside.

The box may further include a switching power supply part supplying power for switching the switching part.

The switching part may be switchable in a vertical direction by the power supplied from the switching power supply part.

The box of claim may further include a dispensing power supply part supplying power for moving the position of the drug accommodation unit by the position moving unit, wherein the power supplied from the dispensing power supply part and the power supplied from the switching power supply part may be different from each other.

The drug accommodation unit may include a rotatable wall partitioning the accommodation space and rotatable to dispense the blister-packaged drugs.

The rotatable wall may be rotated about a rotation shaft by the gravity due to a weight thereof or restoring force due to elastic deformation of a rotation member mounted on the rotation shaft.

The position moving unit may include at least two rotation shafts and a rail part wound around the at least two rotation shafts to orbitally change the position of the drug accommodation unit by the rotation of the at least two rotation shafts.

The blister-packaged drugs may be dispensed by the rotation of the rotatable wall while passing above one of the at least two rotation shafts.

The drug accommodation unit may include a bottom wall coupled to the rail part and on which the blister-packaged drugs are seated, and the rotatable wall may be rotated by using an edge of a side of the bottom wall as a rotation shaft.

The bottom wall may have a predetermined area spaced apart from the rail part while passing above at least one rotation shaft of the at least two rotation shafts.

The rotatable wall may include at least one friction reduction part protruding to reduce frictional force against the blister-packaged drugs when rotated.

The box of may further include: a main body unit providing a predetermined inner space in which the drug accommodation unit is disposed; and a jam prevention part disposed on a moving path of the drug accommodation unit by the position moving unit to prevent the blister-packaged drugs accommodated in the drug accommodation unit from being jammed between the a partition wall partitioning the drug accommodation unit and the main body unit, wherein the jam prevention part may include a protrusion disposed on one of the partition wall and the main body unit and an accommodation part defined in the other one of the partition wall and the main body unit to accommodate the protrusion.

The jam prevention part may have at least one curved portion between the partition wall and the main body unit.

The position moving unit may include at least two rotation shafts and a rail part wound around the at least two rotation shafts to orbitally change the position of the drug accommodation unit by the rotation of the at least two rotation shafts, the partition wall may include a fixed end coupled to the rail part and an opened end disposed adjacent to the main body unit, and the accommodation part may be recessed from the opened end.

The protrusion may be disposed on the moving path of the drug accommodation unit corresponding to a lower side of the at least two rotation shafts on the inner surface of the main body unit.

The protrusion may be disposed on the moving path of the drug accommodation unit passing above the rotation shaft except for the rotation shaft, on which the blister-packaged drugs pass for dispensing, on the inner surface of the main body unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic perspective view of a box for dispensing blister-packaged drugs according to an embodiment of the present invention;

FIG. 2 is a schematic perspective view of a state in which a rotatable unit provided in the box for dispensing the blister-packaged drugs is rotated from a main body unit according to an embodiment of the present invention;

FIGS. 3 and 4 are schematic perspective views of a principle in which a rotatable unit provided in the box for dispensing the blister-packaged drugs is rotated from the main body unit according to an embodiment of the present invention;

FIG. 5 is a schematic perspective view of a state in which blister-packaged drugs are dispensed from a first-row drug accommodation unit provided in the box for dispensing the blister-packaged drugs according to an embodiment of the present invention;

FIG. 6 is a view of a constitution for explaining the state in which the blister-packaged drugs are dispensed from the first-row accommodation unit provided in the box for dispensing the blister-packaged drugs according to an embodiment of the present invention;

FIGS. 7 and 8 are views of a constitution for explaining a principle in which the blister-packaged drugs are dispensed from the first-row accommodation unit provided in the box for dispensing the blister-packaged drugs according to an embodiment of the present invention;

FIG. 9 is view of a constitution for explaining a principle in which a rotatable wall provided on the box for dispensing the blister-packaged drugs is rotated by a rotation member according to an embodiment of the present invention;

FIG. 10 is a view illustrating a modified example of a portion U of FIG. 9;

FIG. 11 is a schematic perspective view of a state in which blister-packaged drugs are dispensed from a second-row accommodation unit provided in the box for dispensing the blister-packaged drugs according to an embodiment of the present invention;

FIG. 12 is a view of a constitution for explaining the state in which the blister-packaged drugs are dispensed from the second-row accommodation unit provided in the blister-packaged drugs according to an embodiment of the present invention;

FIGS. 13 and 14 are schematic views for explaining an operation principle of a switching part for dispensing the blister-packaged drugs from the second-row drug accommodation unit provided in the box for dispensing the blister-packaged drugs according to an embodiment of the present invention;

FIG. 15 is a schematic exploded perspective view for explaining a principle in which the drug accommodation unit provided in the box for dispensing the blister-packaged drugs is fixed to a rail part according to an embodiment of the present invention;

FIG. 16 is a schematic perspective view for explaining a process of feeding the blister-packaged drugs into the box for dispensing the blister-packaged drugs according to an embodiment of the present invention;

FIGS. 17 and 18 are views of a constitution for explaining the process of feeding the blister-packaged drugs into the box for dispensing the blister-packaged drugs according to an embodiment of the present invention;

FIG. 19 is a view of a constitution for explaining a jam prevention unit provided in the box for dispensing the blister-packaged drugs according to an embodiment of the present invention;

FIG. 20 is a schematic exploded perspective view for explaining the jam prevention unit provided in the box for dispensing the blister-packaged drugs according to an embodiment of the present invention;

FIG. 21 is a schematic perspective view illustrating a modified example of the box for dispensing blister-packaged drugs according to an embodiment of the present invention;

FIG. 22 is a view illustrating a constitution of the modified example of the box for dispensing the blister-packaged drugs according to an embodiment of the present invention; and

FIG. 23 is an exploded perspective view illustrating the modified example of the box for dispensing the blister-packaged drugs according to an embodiment of the present invention.

### DETAILED DESCRIPTION OF THE INVENTION

Hereinafter, exemplary embodiments of the present invention will be described with reference to the accompanying drawings. The invention may, however, be embodied in many different forms and should not be construed as being limited to the embodiments set forth herein; rather, that alternate embodiments included in other retrogressive inventions or falling within the spirit and scope of the present disclosure will fully convey the concept of the invention to those skilled in the art.

Also, note that elements having the same function are denoted by the same reference symbol in principle throughout all the drawings for explaining the embodiments.

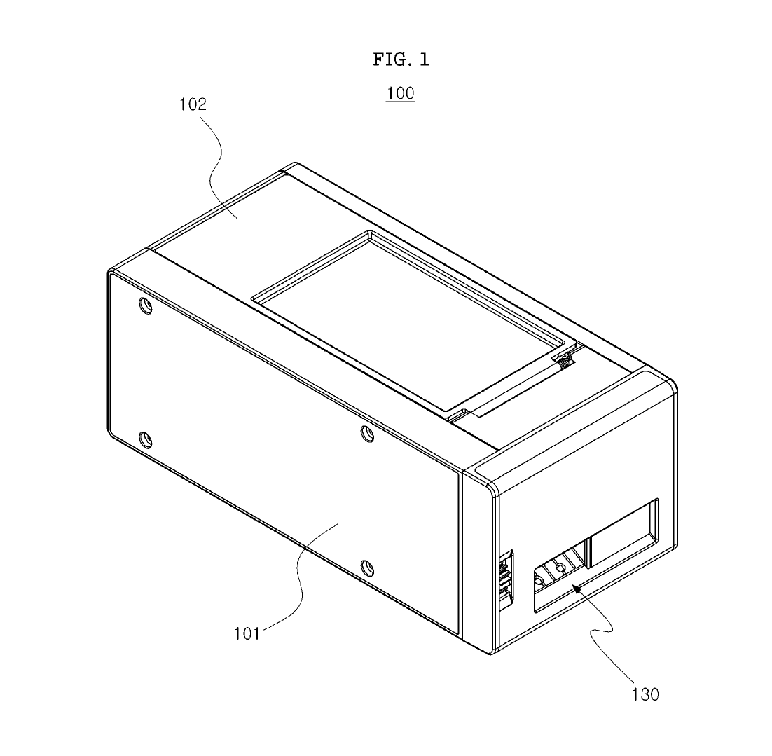

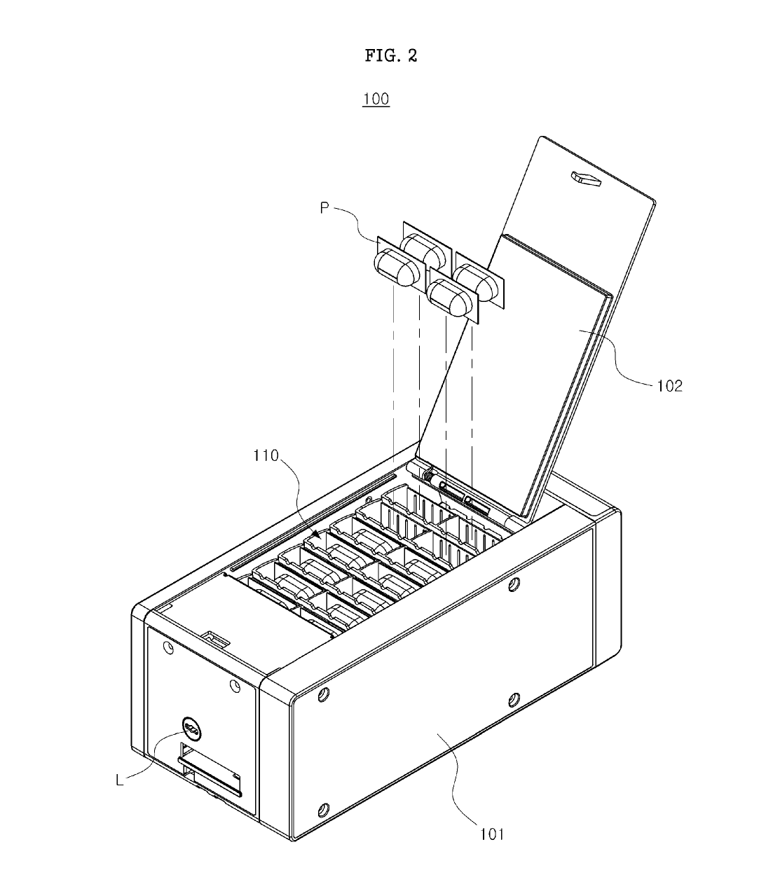

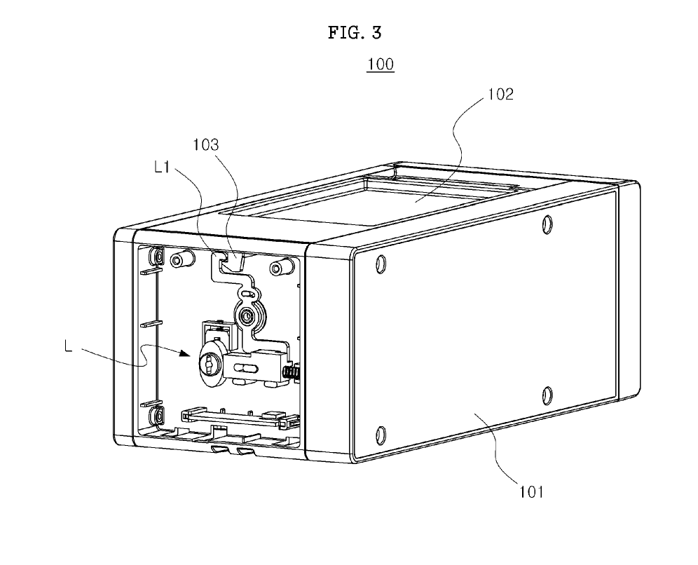

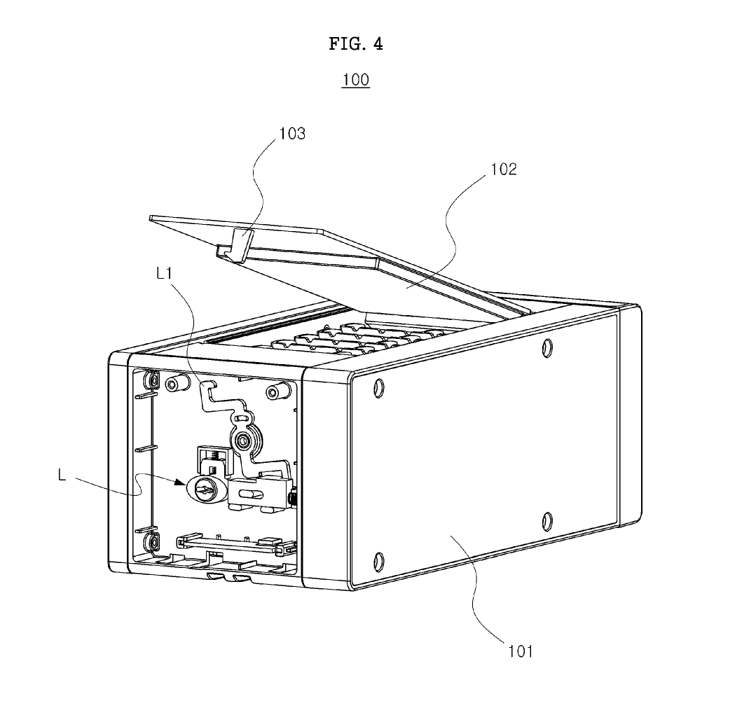

FIG. 1 is a schematic perspective view of a box for dispensing blister-packaged drugs according to an embodiment of the present invention, FIG. 2 is a schematic perspective view of a state in which a rotatable unit provided in the box for dispensing the blister-packaged drugs is rotated from a main body unit according to an embodiment of the present invention, and FIGS. 3 and 4 are schematic perspective views of a principle in which a rotatable unit provided in the box for dispensing the blister-packaged drugs is rotated from the main body unit according to an embodiment of the present invention.

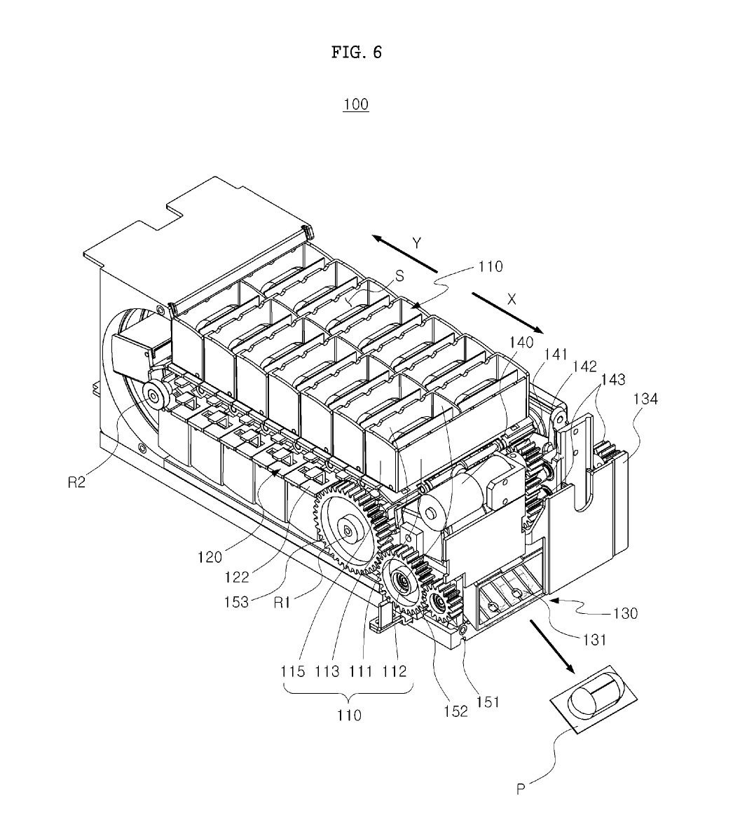

Referring to FIGS. 1 to 4, a box 100 for dispensing blister-packaged drugs according to an embodiment of the present invention may include a drug accommodation unit 110 arranged in at least one row to accommodate a plurality of blister-packaged drugs P, a position moving unit (see reference numeral 120 of FIG. 6), and a dispensing unit 130 for dispensing the blister-packaged drugs P accommodated in the drug accommodation unit 110 to the outside.

That is, the drug accommodation unit 110 may be coupled to the position moving unit 120 and thus be rotated by the rotational movement of the position moving unit 120. Thus, the drug accommodation unit 110 disposed at a predetermined position according to the rotational movement thereof may allow the blister-packaged drugs P to pass through the dispensing unit 130, thereby dispensing the blister-packaged drugs P to the outside.

The box 100 for dispensing the blister-packaged drugs may be a box for dispensing the blister-packaged drugs P one by one to the outside according to a patient's medical prescription. The box 100 for dispensing the blister-packaged drugs P may be fixed to a cartridge of a drug dispensing apparatus together with an ampoule-type drug dispensing box, a pouch-type drug dispensing box, and the like.

That is, the box 100 for dispensing the blister-packaged drugs may be a kind of boxes for dispensing blister-packaged drugs, which are fixed to the cartridge of the drug dispensing apparatus to dispensing the blister-packaged drugs P as necessary if the blister-packaged drugs P are contained in the drugs according to the patient's medical prescription.

Here, after the blister-packaged drugs P accommodated in the box 100 for dispensing the blister-packaged drugs are dispensed through the dispensing unit 130 to the outside, new blister-packaged drugs P may be fed into the drug accommodation unit 110. Thus, the box 100 for dispensing the blister-packaged drugs may be used semipermanently.

That is, the box 100 for dispensing the blister-packaged drugs may include a main body unit 101 providing a predetermined inner space in which the drug accommodation unit 110, the position moving unit 120, and the dispensing unit 130 are disposed. Also, a rotatable unit 102 may be rotatably coupled to the main body unit 101 so that the drug accommodation unit 110 is exposed to the outside.

Thus, the rotatable unit 102 may be rotated from the main body unit 101 to feed the new blister-packaged drugs P into the drug accommodation unit 110. Whether the rotatable unit 102 is rotated may be determined by a locking unit L coupled to a side opposite to the dispensing unit 130.

That is, as shown in FIGS. 3 and 4, the locking unit L may be rotated by using a separate release member so that the rotatable unit 102 is rotated to feed the new blister-packaged drugs P into the drug accommodation unit 110. When the locking unit L is rotated by the release member, a hook 103 of the rotatable unit 102 may be interlocked with the locking unit L and then be separated from a hook corresponding unit L1. As a result, the rotatable unit 102 may be rotated from the main body unit 101.

The release member may be constituted by a kind of keys and then be inserted into the locking unit L as necessary to rotate the rotatable unit 102. However, for professionalism of the drug and prevent drug misadventure from occurring, a separate refill station including a key may be used as the release member.

That is, when the new blister-packaged drugs P are fed into the drug accommodation unit 110 of the box 100 for dispensing the blister-packaged drugs, the box 100 for dispensing the blister-packaged drugs may be separated from the drug dispensing apparatus and then be inserted into the refill station to rotate the locking unit L.

Here, the key that is the release member provided in the refill station may be inserted into the locking unit L to rotate the locking unit L.

Thus, the case in which the refill station is used to rotate the locking unit L may be improved in stability when compared to a case in which an existing release member constituted by only a key is used. Thus, the drug misadventure due to mistake in feeding of drugs may be previously prevented.

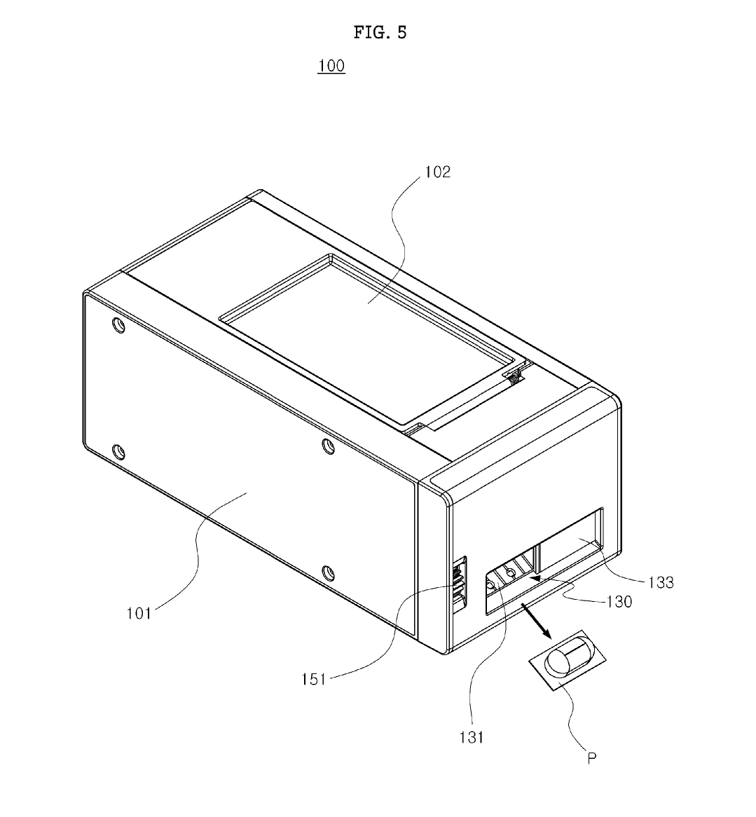

FIG. 5 is a schematic perspective view of a state in which blister-packaged drugs are dispensed from a first-row drug accommodation unit provided in the box for dispensing the blister-packaged drugs according to an embodiment of the present invention, and FIG. 6 is a view of a constitution for explaining the state in which the blister-packaged drugs are dispensed from the first-row accommodation unit provided in the box for dispensing the blister-packaged drugs according to an embodiment of the present invention.

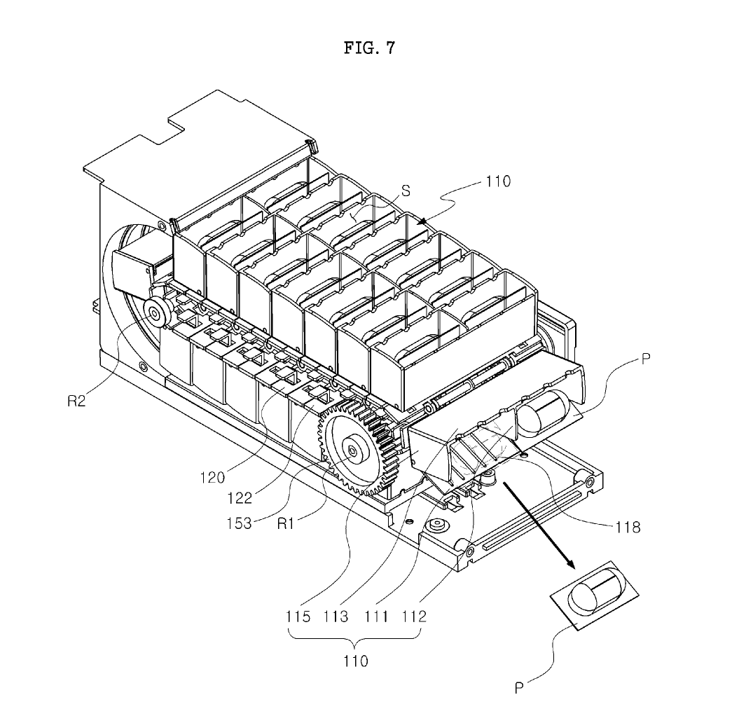

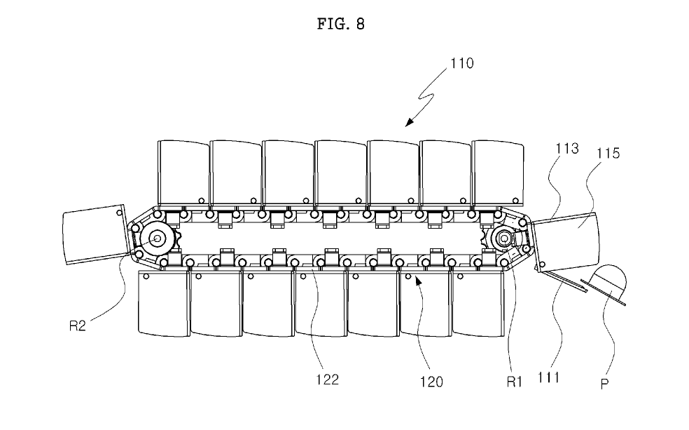

Also, FIGS. 7 and 8 are views of a constitution for explaining a principle in which the blister-packaged drugs are dispensed from the first-row accommodation unit provided in the box for dispensing the blister-packaged drugs according to an embodiment of the present invention.

Referring to FIGS. 5 to 8, the box 100 for dispensing the blister-packaged drugs may include the drug accommodation unit 110 separately accommodating the plurality of blister-packaged drugs P and the position moving unit 120 coupled to the drug accommodation unit 110 to move a position of the drug accommodation unit 110.

First, when defining the term rotation direction, a dispensing direction X may be a direction in which the drug accommodation unit 110 disposed above rotation shafts R1 and R2 is rotated toward the dispensing unit 130 when viewed in FIG. 6. Also, a feeding direction Y may be a rotating direction opposite to the dispensing direction X.

The drug accommodation unit 110 may be provided in plurality. Each of the plurality of accommodation units 110 may have an accommodation space S in which the plurality of blister-packaged drugs P are separately accommodated. Also, the plurality of accommodation units 110 may be arranged in at least one row.

Here, the position moving unit 120 may be orbitally moved by the rotation of the drug accommodation unit 110. The box 100 for dispensing the blister-packaged drugs according to an embodiment of the present invention may successively dispense the blister-packaged drugs P one by one to the outside by the position movement of the drug accommodation unit 110.

That is, the box 100 for dispensing the blister-packaged drugs may dispense the blister-packaged drugs P one by one to the outside through the rotational movement of the drug accommodation unit 110 occurring by the position moving unit 120 regardless of the number of rows of the drug accommodation unit 110.

However, when the drug accommodation unit 110 is provided in two rows, a switching part 133 that will be described later may be provided to successively dispense the blister-packaged drugs P one by one. Alternatively, the drug accommodation units 110 provided in the two rows may be alternately disposed without the switching part 133 to dispense a single blister-packaged drug P.

That is, the drug accommodation units 110 according to the present invention may be disposed in at least one row to dispense the blister-packaged drugs P one by one to the outside as necessary. Hereinafter, for convenience of description, the case in which the drug accommodation units 110 are arranged in the two rows will be described as an example.

The drug accommodation units 110 may be arranged in the two rows. Here, the drug accommodation units 110 may be symmetrical to each other with respect to a boundary of each of the rows.

Thus, the drug accommodation unit 110 together with the drug accommodation unit 110 disposed in the adjacent row may dispense the blister-packaged drugs P to the dispensing unit 130 at the same time.

This may be realized by changing a position of each of the drug accommodation units 110 by the position moving unit 120. The final dispensing of the blister-packaged drugs P may be realized by passing above one of the rotation shafts R1 and R2 of the position moving unit 120.

Here, the position moving unit 120 may include the at least two rotation shafts R1 and R2 and the rail part 122 wound around the at least two rotation shafts R1 and R2 to orbitally change the position of each of the drug accommodation units 110 by rotating the at least two rotation shafts R1 and R2. The blister-packaged drugs P may be dispensed through the dispensing unit 130 by the gravity due to the change in position of the drug accommodation unit 110 while passing above the rotation shaft R1 disposed close to the dispensing unit 130.

Also, a pitch sensor for detecting the change in position of the drug accommodation unit 110 may be provided on the position moving unit 120. The pitch sensor may detect a change in position of the drug accommodation unit 110 with respect to the rotational movement of the position moving unit 120.

Thus, whether the drug accommodation unit 110 is rotated again after the blister-packaged drug is dispensed through the dispensing unit 130 by the rotational movement of the drug accommodation unit 110 may controlled.

The dispensing of the blister-packaged drugs P due to the change in position of the drug accommodation unit 110 may be realized by the rotation of the rotatable wall 111 that partitions the accommodation space S.

The position moving unit 120 may moves the drug accommodation unit 110 toward the dispensing unit 130 by rotating the at least two rotation shafts R1 and R2 to dispense the blister-packaged drugs P through the dispensing unit 130 and then reinstate the drug accommodation unit 110 to its original position.

Here, the dispensing unit 130 may be disposed in the movement direction of the drug accommodation unit 110 to dispense the blister-packaged drugs P accommodated in the drug accommodation units 110 one by one to the outside. Also, the dispensing unit 130 may include a storage part 131 and the switching part 133.

The storage part 131 may temporally store the blister-packaged drugs P that are dispensed at the same time from the drug accommodation units 110 constituting the rows before the blister-packaged drugs P are dispensed to the outside. Here, the switching part 133 may be a kind of opening/closing door through which the blister-packaged drugs P are dispensed one by one from the storage part 131 to the outside.

That is, the dispensing unit 130 may be disposed to correspond to each of the drug accommodation units 110 constituting the rows. Thus, if the drug accommodation units 110 are disposed in the two rows, two dispensing units 130 may be provided.

Here, the switching part 133 may block one of the two storage parts 131 from the outside. This is done for dispensing the blister-package drugs P one by one.

That is, when the blister-packaged drug P is dispensed to the outside from the storage part 131 that is not blocked, the switching part 133 may allow one of the blocked storage parts 131 to communicate with the outside to dispense the blister-packaged drugs P one by one.

In detail, since the drug accommodation units 110 are symmetrical to each other with respect to the boundary of each of the rows, the blister-packaged drug P accommodated in the adjacent drug accommodation unit 110 and the blister-packaged drug P accommodated in the drug accommodation unit 110 may be dispensed at the same time by changing the position of the drug accommodation unit 110 through the position moving unit 120. Thus, if one of the storage part 131 is not blocked by the switching part 133, two blister-packaged drugs P may be dispensed at the same time to the outside.

Thus, to successively dispense the blister-packaged drugs P one by one, the switching part 133 may open the blocked storage part 131 to dispense the blister-packaged drug P after the blister-packaged drug P is dispensed from the storage that is not blocked to the outside.

Here, power for switching the switching part 133 may be provided by a switching power supply unit 140. The switching part supply unit 140 may be a small motor disposed within the main body unit 101 of the box 100 for dispensing the blister-packaged drugs according to the present invention.

A switching power rotation part 141 that is a kind of spur gears may be coupled to the rotation shaft rotated by the switching power supply part 140. The switching power rotation part 141 may be interlocked with the switching power supply part 143 for switching the switching part 133 by a switching power medium part 142.

That is, the switching power rotation part 141, the switching power medium part 142, and a switching power transmission part 143 may be a kind of spur gears and be engaged with each other. When the switching power rotation part 141 is rotated by the switching power supply part 140, the switching power medium part 142 may be rotated, and thus, the switching power transmission part 143 may also be rotated.

Thus, when the switching power transmission part 143 is rotated, a switching movement part 134 coupled to an end of the switching part 133 may be moved upward by the rotation of the switching power transmission part 143 to open the switching part 133.

Here, the switching movement part 134 may be a rack gear that is a kind of linear gears, which is movable upward by the rotation of the switching power transmission part 143 that is a kind of spur gears. After the switching part 133 is opened, the switching power supply part 140 may convert a rotation direction to close the switching part 133 again.

Thus, the switching, i.e., the opening/closing of the switching part 133 may be automatically controlled by the switching power supply part 140. Here, the switching power supply part 140 may be different from a dispensing power supply part 151 that provides power for rotating the position moving unit 120.

Here, the dispensing power supply part 151 may be a kind of spur gears. Thus, when the box 100 for dispensing the blister-packaged drugs according to the present invention is fixed to the cartridge of the drug dispensing apparatus, the dispensing power supply part 151 may be automatically engaged with one component of the drug dispensing apparatus according to the patient's medical prescription to receive external power. Thus, the dispensing power supply part 151 may be rotated by the received external power.

When the dispensing power supply part 151 is rotated by the external power as described above, the rotation power of the dispensing power supply part 151 may rotate the dispensing power transmission part 153 that is coupled to and interlocked with the rotation shaft R1 of the position moving unit 120 and thus is rotated by the rotation shaft R1.

Here, the dispensing power transmission part 153 may be rotated by the rotation power of the dispensing power supply part 151 by using the dispensing power medium part 152 as a medium. This may be realized by engaging the parts that are the spur gears with each other.

Thus, the power for rotating the position moving unit 120 and the power for switching the switching part 133 may be different from each other in that the power for rotating the position moving unit 120 is external power, and the power for switching the switching part 133 is internal power.

The dispensing of the blister-packaged drugs P from the drug accommodation unit 110 rotated by the dispensing power supply part 151 may be realized by the rotation of the rotatable wall 111 partitioning the accommodation space S. The rotatable wall 111 may be rotated by the position moving unit 120 when the drug accommodation unit 110 is disposed at a predetermined position.

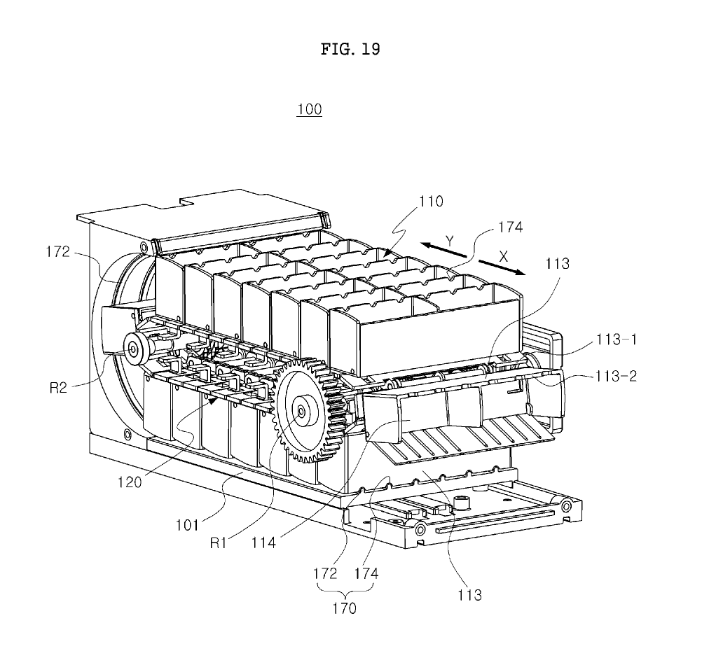

Here, the drug accommodation unit 110 may include a plurality of walls to partition the accommodation space S. In detail, the plurality of walls may include a bottom wall (see reference numeral 114 of FIG. 19) on which the blister-packaged drugs P are seated and coupled to the rail part 122, a partition wall 113 extending from an edge of the other side of the bottom wall 114 to the outside of the rail part 122, a boundary wall 112 setting a boundary for partitioning one drug accommodation unit 110 from the drug accommodation unit 110 disposed in the adjacent row, and sidewalls 115 constituting outer walls of the one drug accommodation unit 110 and the drug accommodation unit 110 disposed in the adjacent row.

Also, the rotatable wall 111 may be rotated by using an edge of one side of the bottom wall 114 as a rotation shaft.

The rotatable wall 111 may be rotated by the gravity due to a weight thereof with respect to the rotation shaft. The rotation of the rotatable wall 111 may be realized by passing above one of the at least two rotation shafts R1 and R2 of the position moving unit 120.

That is, the rotatable wall 111 may not be rotated when the rotatable wall 111 passes through an upper side, a lower side, and the rotation shaft R2 except for the rotation shaft R1 of the at least two rotation shafts R1 and R2, which is disposed adjacent to the dispensing unit 130. Thus, the rotatable wall 111 may be rotated only when the rotatable wall 111 passes through the rotation shaft R1 disposed adjacent to the dispensing unit 130.

That is, it is assumed that the drug accommodation unit 110 is moved in the dispensing direction X by the rotation of the position moving unit 120, when the drug accommodation unit 110 is disposed above the at least two rotation shafts R1 and R2, the rotatable walls 111 of the drug accommodation units 110 may be arranged in the same row and may not be rotated in the dispensing direction X by the partition wall 113 of the adjacent drug accommodation unit 110.

Also, the rotatable wall 111 of the drug accommodation unit 110 may contact the boundary wall 112 and thus may not be rotated into the accommodation space S of the drug accommodation unit 110.

Similarly, when the drug accommodation unit 110 is disposed under the at least two rotation shafts R1 and R2 and is moved, the rotation of the rotatable wall 111 may also be prevented.

Also, in the case where the drug accommodation unit 110 is moved in the dispensing direction X, when the drug accommodation unit 110 is moved from the lower side to the upper side of the at lest two rotation shafts R1 and R2, the rotation of the drug accommodation unit into the accommodation space S may be prevented by contacting the boundary wall 112.

As a result, the rotatable wall 111 of the drug accommodation unit 110 may be rotated only when the rotatable wall 111 is moved from the upper side to the lower side of the rotation shaft R1 disposed adjacent to the dispensing unit 130, i.e., the at least two rotation shafts R1 and R2. Thus, the blister-packaged drugs P may freely fall by the rotation of the rotatable wall 111 and thus be dispensed into the dispensing unit 130.

However, the present invention is not limited to the rotation of the rotatable wall 111 that is realized by the gravity due to the weight of the rotatable wall 111 with respect to the rotation shafts R1 and R2. For example, the rotatable wall 111 may be rotated by separate rotation members 119a and 119b.

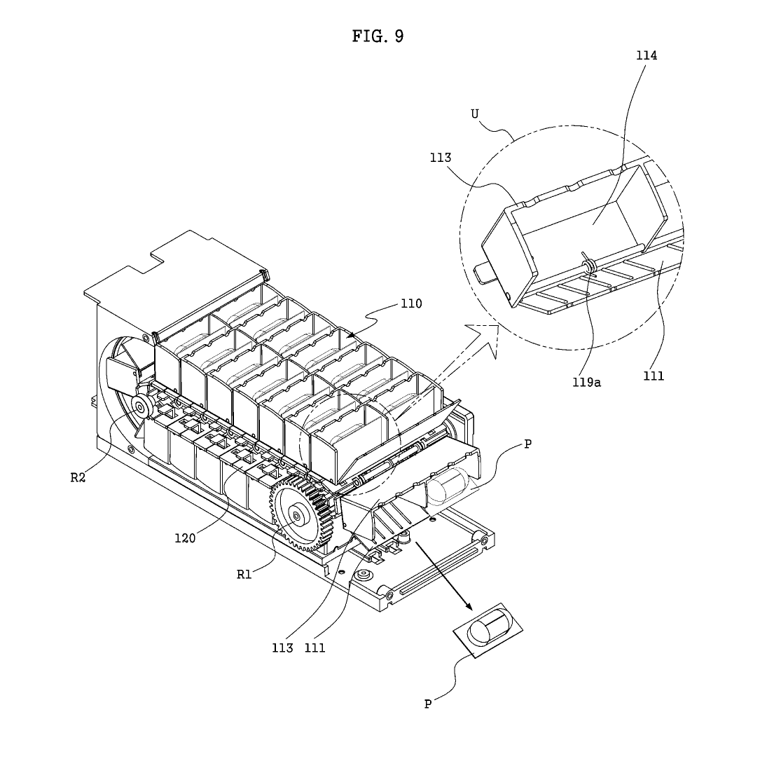

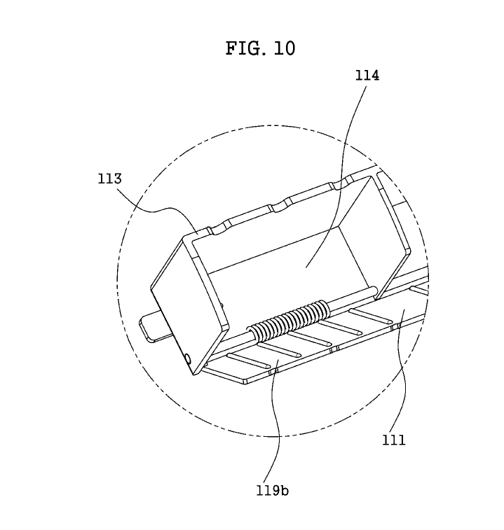

These operations will be described later with reference to FIGS. 9 and 10.

A predetermined area of the bottom wall 114 of the drug accommodation unit 110 may be spaced apart from the rail part 122 while passing above the at least one rotation shaft R1 of the at least two rotation shafts R1 and R2.

That is, when the bottom wall 114 of the drug accommodation unit 110 is moved from the upper side to the lower side of the at least two rotation shafts R1 and R2, a predetermined area of the bottom wall 114 may be spaced apart from the rail part 122.

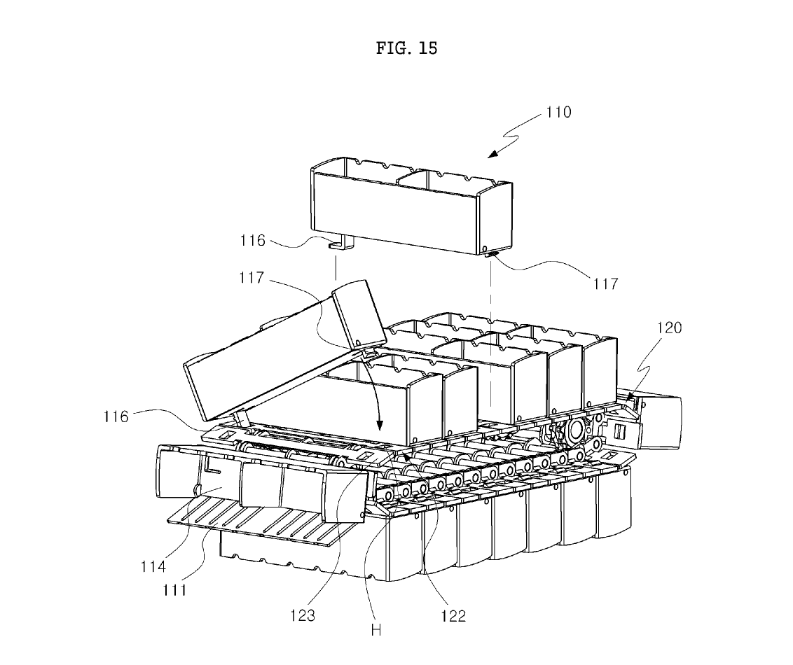

This is done due to the coupling method of the position moving unit 120. The coupling method between the rail part 122 and the position moving unit 120 may be a coupling method in which a coupling protrusion (see reference numeral 116 of FIG. 15) and a detachable protrusion (see reference numeral 117 of FIG. 15) which protrude from the bottom wall 114 of the drug accommodation unit 110 are inserted into a coupling hole H defined in the rail part 122.

This structure will be described later with reference to FIG. 15.

When the drug accommodation unit 110 is moved from the upper side to the lower side of the at least two rotation shafts R1 and R2 by the position movement of the position moving unit 12Q, the blister-packaged drugs P may be dispensed. Here, frictional force between the rotatable wall 111 and the blister-packaged drugs P may be reduced to effectively dispense the blister-packaged drugs P into the dispensing unit 130.

That is, a friction reduction part 118 may protrude from one surface of the rotatable wall 111. Here, at least one friction reduction part 118 may be continuously disposed along the dispensing direction X of the blister-packaged drugs P.

Thus, when the blister-packaged drugs P are dispensed, the rotatable wall 111 and the blister-packaged drugs P may linearly contact to dispense the blister-packaged drugs P into the dispensing unit 130 at minimum frictional force.

Also, the friction reduction part 118 may be provided on the storage part 131. Thus, when the blister-packaged drugs P are dispensed, frictional force between the storage part 131 and the blister-packaged drugs P may be reduced to effectively dispense the blister-packaged drugs P to the outside.

However, the present invention is not limed to the at least one friction reduction part 118 continuously disposed along the dispensing direction X of the blister-packaged drugs P. For example, a plurality of friction reduction parts 118 may be provided in a projection shape.

FIG. 9 is view of a constitution for explaining a principle in which the rotatable wall provided on the box for dispensing the blister-packaged drugs is rotated by the rotation member according to an embodiment of the present invention, and FIG. 10 is a view illustrating a modified example of a portion U of FIG. 9.

Referring to FIGS. 9 and 10, the rotatable wall 11 may be rotated by using the edge of the one side of the bottom wall 114 as the rotation shaft. This may be realized by restoring force of the rotation members 119a and 119b mounted on the rotation shafts R1 and R2.

Here, each of the rotation members 119a and 119b may be a kind of elastic members having elasticity. Each of the rotation members 119a and 119b may be a torsion sparing or a coil spring as shown in FIGS. 9 and 10.

The rotatable wall 111 may be rotated by the restoring force due to the elasticity while passing above the rotation shaft R1 disposed adjacent to the dispensing unit 130. In detail, the rotatable wall 111 may be rotated just when the rotatable wall 111 is spaced apart from the partition wall 113 of the adjacent drug accommodation unit 110 that is disposed in the same row.

That is, it is assumed that the drug accommodation unit 110 is moved in the dispensing direction X by the rotation of the position moving unit 120, the foremost drug accommodation unit 110 of the drug accommodation units 110 above the rotation shafts R1 and R2 may be automatically rotated by the restoring force due to the rotation members 119a and 119b just when the foremost drug accommodation unit 110 is spaced apart from the drug accommodating unit 110 through which the drug P is dispensed.

Also, the rotatable wall 111 of the foremost drug accommodation unit 110 of the drug accommodation units 110 above the rotation shafts R1 and R2 may be rotated to dispense the accommodated drug P by the rotation of the position moving unit 120 just when the rotatable wall 111 is spaced apart from the drug accommodation unit 110 through the drug P is dispensed. Then, the rotatable wall 111 may be moved to the lower side of the rotation shaft R1 to slowly return to its original position while the rotatable wall 111 is elastically deformed just when contacting the partition wall 113 of the drug accommodation unit 110 through which the drug P is dispensed.

Here, the position moving unit 120 may have sufficient rotation force so that the rotation members 119a and 119b are elastically deformed.

Also, the rotatable wall 111 of the hindmost drug accommodation unit 110 of the drug accommodation units 110 moved along the lower side of the rotation shafts R1 and R2 may be automatically rotated by the restoring force due to the rotation members 119a and 119b just when the rotatable wall 111 is spaced apart from the drug accommodation unit 110 disposed at the hindmost side just before movement.

Also, the rotatable wall 111 of the hindmost drug accommodation unit 110 of the drug accommodation units 110 may be moved to the upper side of the rotation shaft R2 to slowly return to its original position while being elastically deformed just when the rotatable wall 111 contacts the partition wall 113 of the drug accommodation unit 110 moved to the upper side of the rotation shaft R2 just before movement.

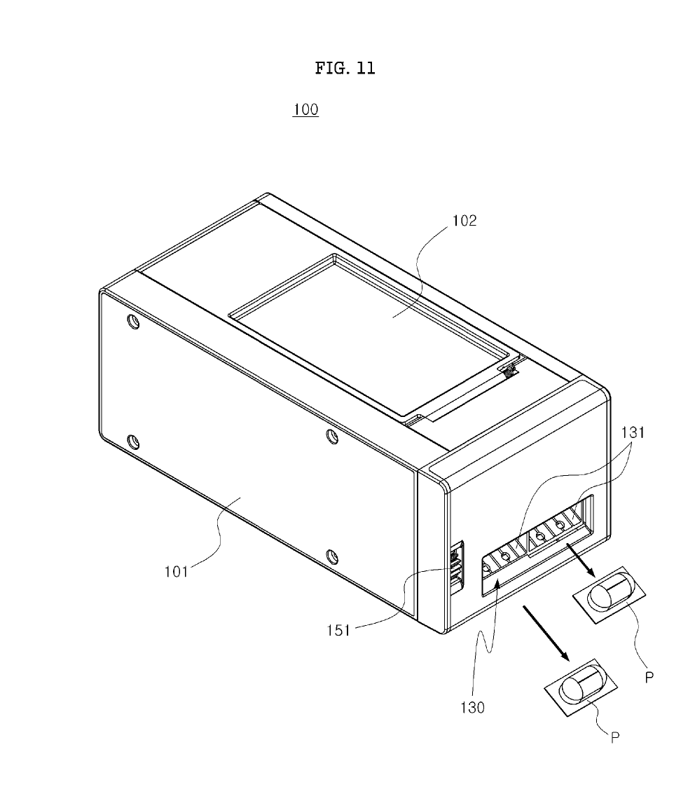

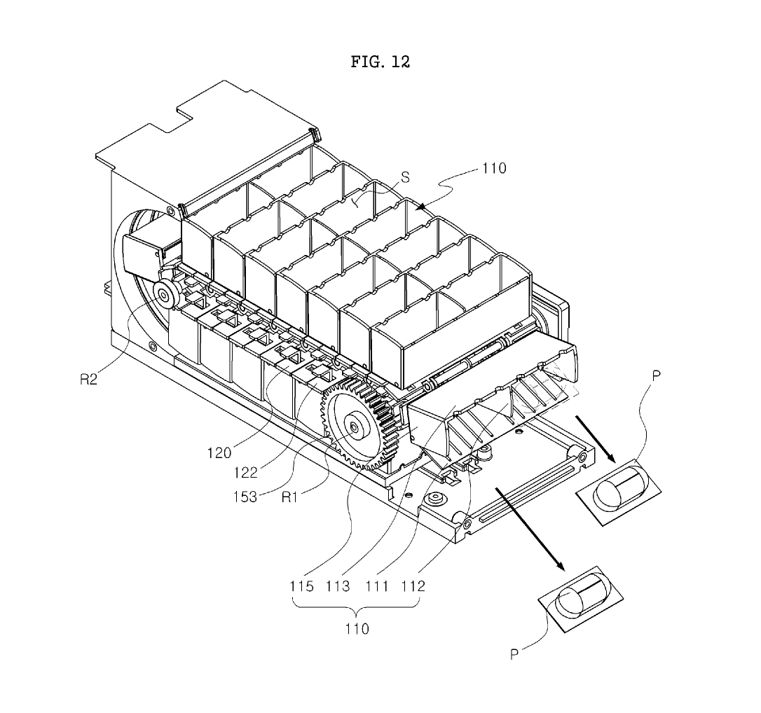

FIG. 11 is a schematic perspective view of a state in which blister-packaged drugs are dispensed from a second-row accommodation unit provided in the box for dispensing the blister-packaged drugs according to an embodiment of the present invention, and FIG. 12 is a view of a constitution for explaining the state in which the blister-packaged drugs are dispensed from the second-row accommodation unit provided in the blister-packaged drugs according to an embodiment of the present invention.

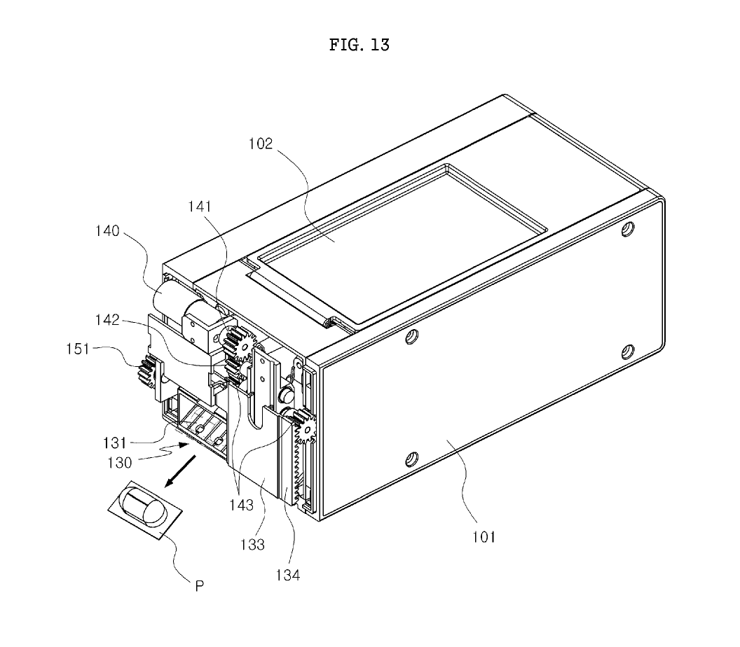

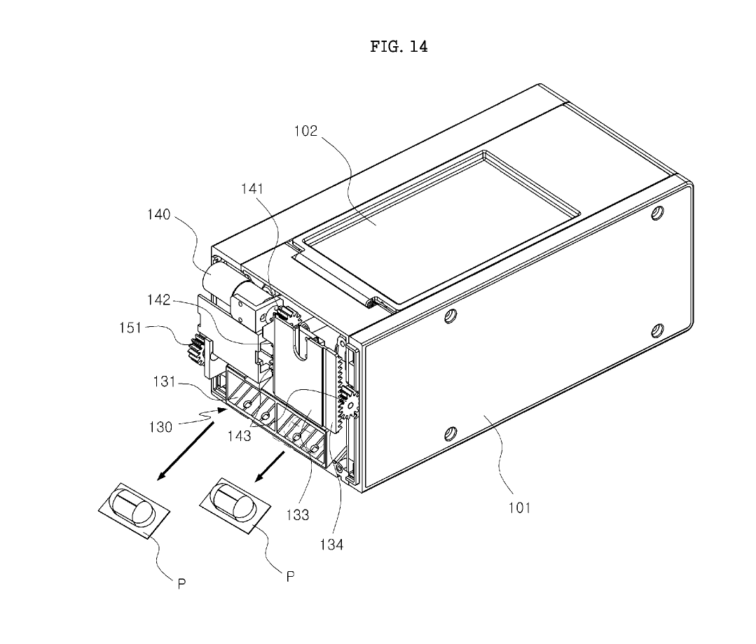

Also, FIGS. 13 and 14 are schematic views for explaining an operation principle of the switching part for dispensing the blister-packaged drugs from the second-row drug accommodation unit provided in the box for dispensing the blister-packaged drugs according to an embodiment of the present invention.

Referring to FIGS. 11 to 14, as described with reference to FIGS. 5 to 10, the dispensing unit 130 for dispensing the blister-packaged drugs P may include the storage part 131 and the switching part 133.

Here, when the drug accommodation units 110 of the box 100 for dispensing the blister-packaged drugs are disposed in the two rows, the blister-packaged drugs P accommodated in one drug accommodation unit 110 and the drug accommodation unit 110 disposed in the adjacent row may be dispensed at the same time by the rotation of each of the drug accommodation units 110 through the position moving unit 120.

Here, the blister-packaged drugs P may be successively dispensed one by one. As described above, the dispensing of the blister-packaged drugs P may be realized by switching the switching part 133.

That is, the blister-packaged drug P, which is dispensed into the storage part 131 in which the switching part 133 is not disposed, of the blister-packaged drugs P dispensed into the storage part 131 at the same time may be smoothly dispensed to the outside. Then, if it is intend to dispense the other blister-packaged drug P, the storage part 131 closed by the switching part 133 may be opened to dispense the other blister-packaged drug P.

In this case, the switching part 133 may be opened to dispense the other blister-packaged drug P, and the power for switching the switching part 133 may be received by the switching power supply part 140.

The switching power rotation part 141 may be coupled to the switching power supply part 140. The switching power rotation part 141 may be interlock with the switching power transmission part 143 to switch the switch part 133 by the switching power medium part 142.

That is, when the switching power rotation part 141 is rotated by the switching power supply part 140, the switching power medium part 142 may be rotated, and thus, the switching power supply part 143 may also be rotated.

Thus, when the switching power transmission part 143 is rotated, the switching moving part 134 coupled to the end of the switching part 133 may be moved upward by the rotation of the switching power transmission part 143 to open the switching part 133.

FIG. 15 is a schematic exploded perspective view for explaining a principle in which the drug accommodation unit provided in the box for dispensing the blister-packaged drugs is fixed to the rail part according to an embodiment of the present invention.

Referring to FIG. 15, the rail part 122 and the drug accommodation unit 110 may be coupled to each other by respectively inserting the coupling protrusion 116 and the detachable protrusion 117 protruding from the bottom wall 114 of the drug accommodation unit 110 into the coupling holes H defined in both sides of the rail part 122.

That is, the coupling protrusion 116 may protrude from a side of a bottom surface of the bottom wall 114 and then bent outward. Thus, the coupling protrusion 116 may have an “L” shape on the whole. The detachable protrusion 117 may have a semi-arrowhead shape so that the detachable protrusion 117 is fitted into the coupling hole H.

Thus, when the detachable protrusion 117 is fitted into the coupling hole H by external force after the coupling protrusion 116 is inserted into the coupling hole H, the drug accommodation unit 110 may be stably fixed to the rail part 122.

The rail part 122 may be constituted by a plurality of rail elements 123 connected to each other. The bottom wall 114 of the drug accommodation unit 110 may correspond to two rail elements 123.

Alternatively, the coupling protrusion 116 and the detachable protrusion 117 protruding from the bottom wall 114 may be coupled to the coupling holes H defined in both ends of one rail element 123.

Thus, when the drug accommodation unit 110 is rotated in the dispensing direction X, a predetermined area of the bottom wall 114 of the drug accommodation unit 110 may be spaced apart from the rail part 122 while passing above at least one rotation shaft R1 of the rotation shafts R1 and r2.

That is, a predetermined area of the bottom wall 114 of the drug accommodation unit 110 may be spaced apart from the rail part 122 when the bottom wall 114 of the drug accommodation unit 110 is moved from the upper side to the lower side of the at least two rotation shafts R1 and R2.

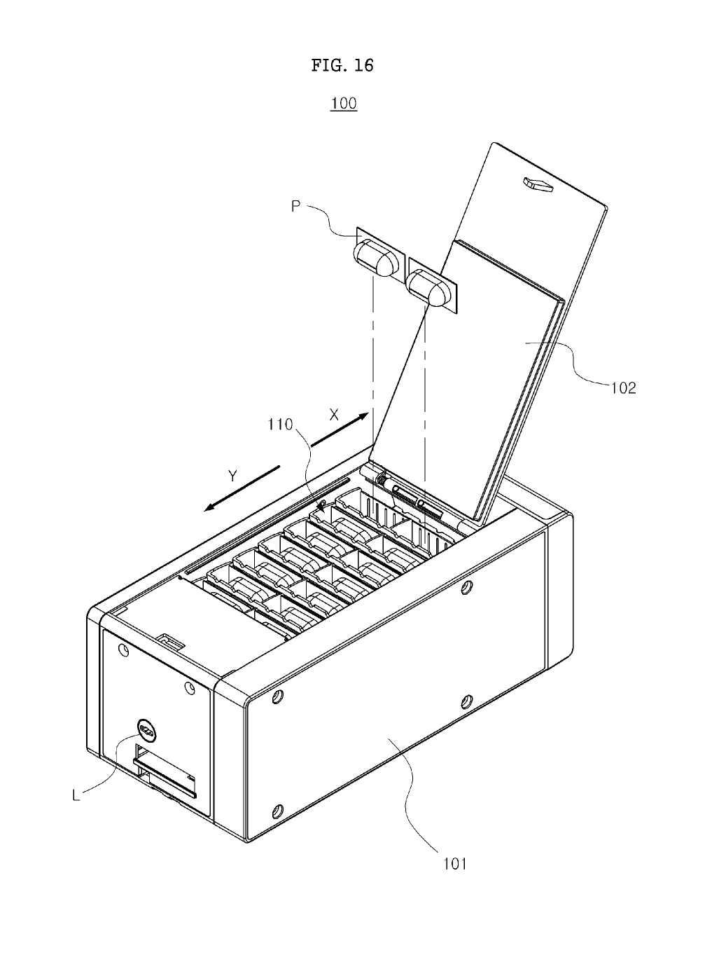

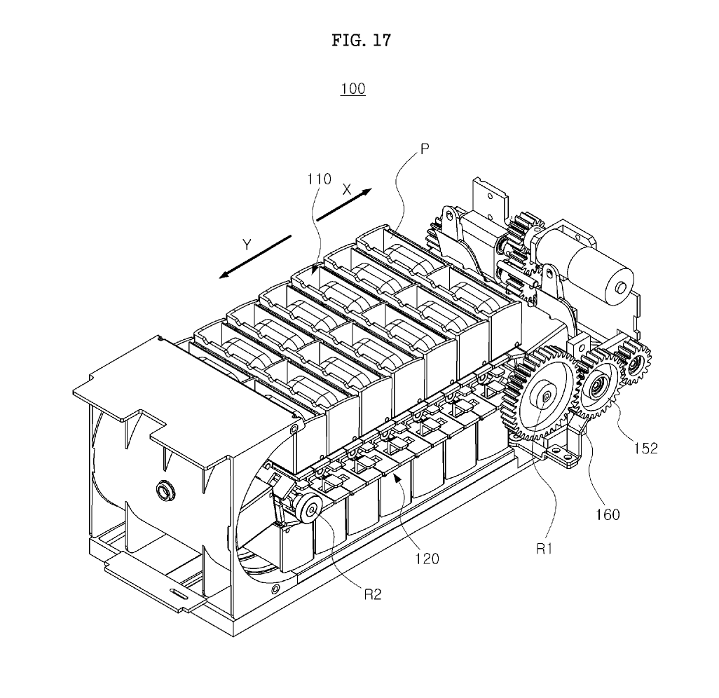

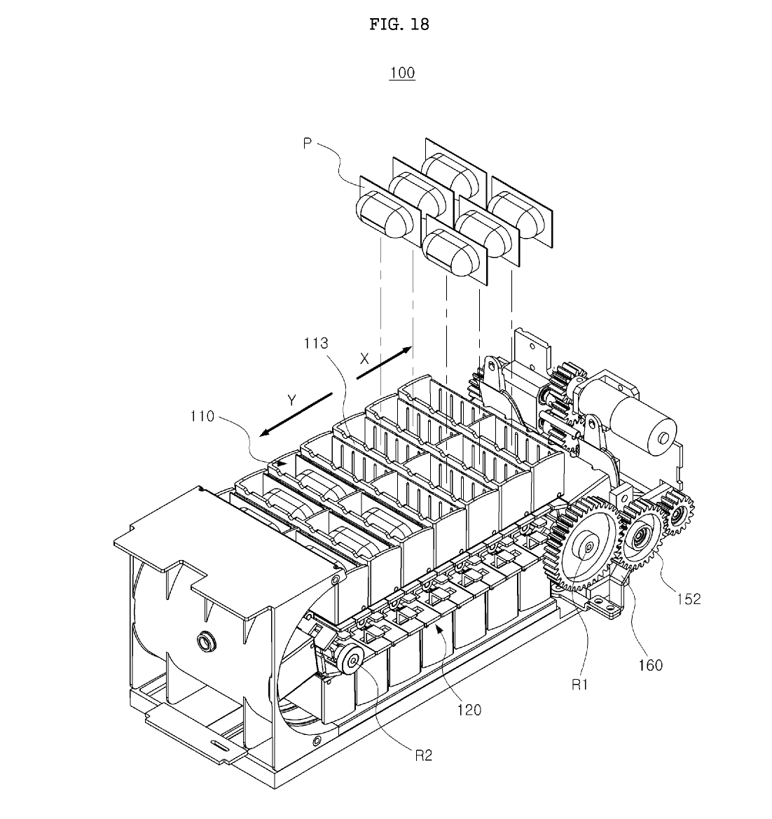

FIG. 16 is a schematic perspective view for explaining a process of feeding the blister-packaged drugs into the box for dispensing the blister-packaged drugs according to an embodiment of the present invention, and FIGS. 17 and 18 are views of a constitution for explaining the process of feeding the blister-packaged drugs into the box for dispensing the blister-packaged drugs according to an embodiment of the present invention.

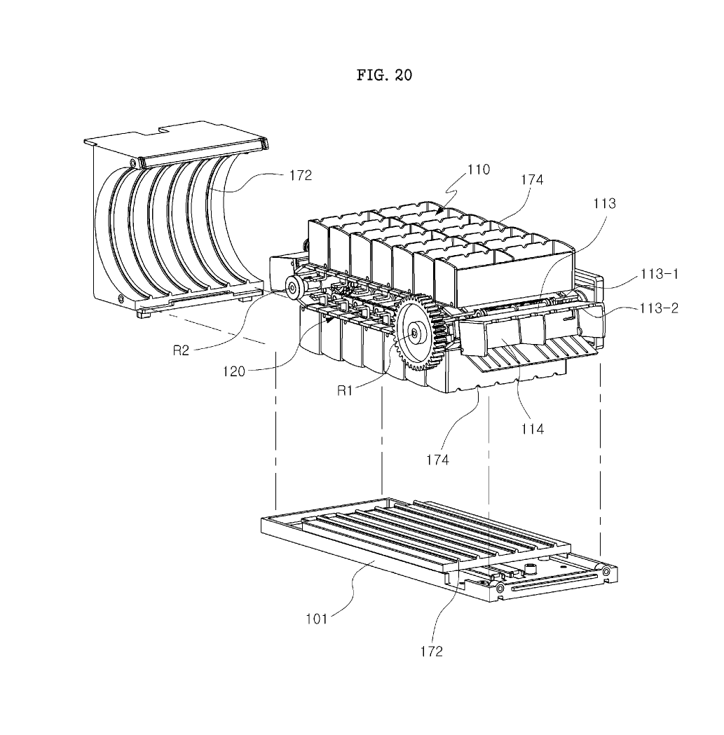

FIG. 19 is a view of a constitution for explaining a jam prevention unit provided in the box for dispensing the blister-packaged drugs according to an embodiment of the present invention, and FIG. 20 is a schematic exploded perspective view for explaining the jam prevention unit provided in the box for dispensing the blister-packaged drugs according to an embodiment of the present invention.

Referring to FIGS. 16 to 20, in the box 100 for dispensing the blister-packaged drugs, when all of the accommodated blister-packaged drugs P are dispensed from the drug accommodation unit 110 to the outside through the dispensing unit 130, the rotatable unit 102 may be rotated from the main body unit 101 to feed new blister-packaged drugs P into the empty drug accommodation unit 110.

Here, as shown in FIGS. 1 to 3, the box 100 for dispensing the blister-packaged drugs may be separated from the drug dispensing apparatus and then be inserted into the refill station to rotate the locking unit L, thereby rotating the rotatable unit 102.

Here, the key that is the release member provided in the refill station may be automatically inserted into the locking unit L to rotate the locking unit L.

When the rotatable unit 102 is rotated from the main body unit 101 to expose the drug accommodation unit 110 to the outside, the new blister-packaged drugs P may be fed into the drug accommodation unit 110 to automatically or manually rotate the drug accommodation unit 110 in the feeding direction Y that is opposite to the dispensing direction X, thereby completing the feeding of the blister-packaged drugs P into all of the drug accommodation units 110.

Here, to rotate the drug accommodation unit 110, i.e., to rotate the drug accommodation unit 110 in the feeding direction Y of the position moving unit 120, a moving prevention part 160 that contacts the dispensing power medium part 152 to prevent the drug accommodation unit 110 from being moved has to be separated from the dispensing power medium part 152. This may be realized by a separation induction part provided in the refill station.

Also, when the blister-packaged drugs P are dispensed from the drug accommodation unit 110 by the rotation of the position moving unit 120, the moving prevention part 160 may be separated from the dispensing power medium part 152 by a separation induction part provided in the cartridge of the drug dispensing apparatus.

When the blister-packaged drugs P are dispensed from and fed into the drug accommodation unit 110, a jam prevention part 170 may prevent the blister-packaged drugs P from being jammed between the partition wall 113 and the main body unit 101.

Hereinafter, the possibility in an occurrence of the jam of the blister-packaged drugs P between the partition wall 113 and the main body unit 101 according to the position and rotation direction of the drug accommodation unit 110 will be described.

First, when the blister-packaged drugs P are accommodated into all of the drug accommodation units 110 and then are dispensed from the drug accommodation units 110 by the rotation of the position moving unit 120, in the drug accommodation unit 110 passing above the at least two rotation shafts R1 and R2, the blister-packaged drugs P may not be jammed between the partition wall 113 and the main body unit 101.

This is done because the blister-packaged drugs P are moved in a state where the blister-packaged drugs P are seated on the bottom wall 114 of the drug accommodation unit 110 when the drug accommodation unit 110 passes above the at least two rotation shafts R1 and R2.

Also, when the drug accommodation unit 110 passes under the at least two rotation shafts R1 and R2 after the blister-packaged drugs P are dispensed while passing above the rotation shaft R1 disposed adjacent to the dispensing unit 130, the blister-packaged drugs P may not be jammed between the partition wall 113 and the main body unit 101.

However, when the drug accommodation unit 110 passes under the at least two rotation shafts R1 and R2 and passes through the rotation shaft R1 except for the rotation shaft R1 of the at least two rotation shaft R1 and R2, which is disposed adjacent to the dispensing unit 130, in a state where the blister-packaged drugs P are accommodated in the drug accommodation units 110 before the blister-packaged drugs P are dispensed from the drug accommodation units 110, the blister-packaged drugs P may be seated on an inner surface of the main body unit 101 by the gravity. Thus, the possible in an occurrence of the jam of the blister-packaged drugs P between the partition wall 113 and the main body unit 101 may increase.

Also, when the blister-packaged drugs P are dispensed from the drug accommodation unit 110 and then the new blister-packaged drugs P are fed while rotating the drug accommodation unit 110 in the feeding direction Y, the possible in an occurrence of the jam of the blister-packaged drugs P between the partition wall 113 and the main body unit 101 may increase, like when the drug accommodation unit 110 in which the new blister-packaged drugs P are fed passes above the rotation shaft R2 except for the rotation shaft R1 of the at least two rotation shafts R1 and R2, which is disposed adjacent to the dispensing unit 130 and passes under the at least two rotation shafts R1 and R2 as described above.

Thus, to reduce the possibility in the occurrence of the jam of the blister-packaged drugs P between the partition wall 113 and the main body unit 101 and minimize an interference between the partition wall 113 and the inner surface of the main body unit 101 to smoothly rotate the drug accommodation unit 110, a distance between the partition wall 113 and the main body unit 101 may be minimized and also, the partition wall 113 and the main body unit 101 may be minutely spaced to correspond to each other.

This may means that an opened end 113-2, which is an end of the partition wall 113, of the partition wall 113 and the inner surface of the main body unit 101 have to approach each other so as to maintain the contact state between the opened end 113-2 and the inner surface of the main body unit 101 or minimize the distance between the opened end 113-2 and the inner surface of the main body unit 101.

Thus, since a moving path along which the partition wall 113 of the drug accommodation unit 110 pass above the rotation shaft R2 except for the rotation shaft R1 of the at lest two rotation shafts R1 and R2, which is disposed adjacent to the dispensing unit 130 has a rounded shape, the inner surface of the main body unit 101 corresponding to the moving path may have a rounded shape. Thus, the opened end 113-2 that is the end of the partition wall 113 and the inner surface of the main body unit 101 may contact or approach each other.

Also, when the drug accommodation unit 110 passes under the at least two rotation shafts R1 and R2, the opened end 113-2 of the partition wall 113 and the inner surface of the main body unit 101 may contact or approach each other.

Here, when the opened end 113-2 that is the end of the partition wall 113 and the inner surface of the main body unit 101 correspond to contact or approach each other, the possibility in the occurrence of the jam of the blister-packaged drugs P between the partition wall 113 and the main body unit 101 may be reduced. However, it may be difficult to completely prevent the blister-packaged drugs P from being jammed between partition wall 113 and the main body unit 101 due to the feature of a blister-packing paper.

Thus, the present invention may provide the jam prevention part 170 to previously prevent the blister-packaged drugs P from being jammed between partition wall 113 and the main body unit 101 and minimize the interference between the partition wall 113 and the inner surface of the main body unit 101 to smoothly rotate the drug accommodation unit 110.

In detail, the jam prevention part 170 may be disposed on the moving path of the drug accommodation unit 110 defined by the position moving unit 120. Also, accommodation parts 174 for accommodating the protrusion 172 disposed on one of the partition wall 113 and the main body unit 101 and the protrusion 172 disposed on the other one of the partition wall 113 and the main body unit 101 may be further provided.

The jam prevention part 170 may have at least one curved portion between the partition wall 113 and the main body unit 101 to prevent the blister-packaged drugs P from being jammed between the partition wall 113 and the main body unit 101. Also, the protrusion 172 and the accommodation part 174 constituting the jam prevention part 170 may have shapes corresponding to each other.

However, the prevent invention is not limited to the protrusion 172 and the accommodation part 174 which correspond to each other. For example, any structure in which a curved portion is provided between the partition wall 113 and the main body unit 101 may be applied to the prevent invention.

Here, the partition wall 113 may include a fixed end coupled to the rail part 122 and the above-described opened end 113-2 disposed adjacent to the main body unit 101. The accommodation part 174 may be recessed from the opened end 113-2 of the partition wall 113.

Also, the accommodation part 174 may be provided in plurality that are spaced apart from each other, and also, the protrusion 172 may be the same.

The protrusion 172 may be disposed on an entire area of the inner surface of the main body unit 101. Alternatively, the protrusion 172 may be disposed on only a portion at which the blister-packaged drugs P may be jammed between the partition wall 113 and the main body unit 101.

That is, the protrusion 172 may be disposed on the moving path of the drug accommodation unit 110 corresponding to the lower side of the at least two rotation shafts R1 and R2 on the inner surface of the main body unit 101. Alternatively, the protrusion 172 may be disposed on the moving path of the drug accommodation unit 110 passing above the rotation shaft R2 except for the rotation shaft R1 on which the blister-packaged drugs P pass for dispensing.

That is, when the position moving unit 120 may be rotated in the feeding direction Y that is opposite to the dispensing direction X to rotate the drug accommodation unit 110, thereby feeding the blister-packaged drugs P into the drug accommodation unit 110, the protrusion 172 may be disposed on only the moving path in which the drug accommodation unit 110 is moved on the inner surface of the main body unit 101 from the upper side to the lower side of the at least two rotation shafts R1 and R2 and the moving path in which the drug accommodation unit 110 passes under the lower side of the at least two rotation shafts R1 and R2.

Thus, when the position moving unit 120 is rotated in the feeding direction Y to feed the blister-packaged drugs P into the drug accommodation unit 110, it may previously prevent the blister-packaged drugs P from being jammed or hooked between the partition wall 113 and the main body unit 101 by the jam prevention part 170.

Also, when the drug accommodation unit 110 is rotated to dispense the blister-packaged drugs P after the blister-packaged drugs P are accommodated in the drug accommodation unit 110, the above-described operations may be applied to the prevent invention as it is.

Therefore, the jam prevention part 170 may previously prevent the blister-packaged drugs P from being jammed and perform a guide function to smoothly rotate the drug accommodation unit 110.

The blister-packaged drugs P may be seated on the protrusion 172 in at least one case of the case in which the drug accommodation unit 110 passes under the at least two rotation shafts R1 and R2 in the state where the drug accommodation unit 110 accommodates the blister-packaged drugs P before the blister-packaged drugs P are dispensed from the drug accommodation unit 110 and the case in which the drug accommodation unit 110 passes above the rotation shaft R2 except for the rotation shaft R1 of the at least two rotation shafts R1 and R2, which is disposed adjacent to the dispensing unit 130. In this case, the blister-packaged drugs P may be moved on the protrusion 172.

Also, the blister-packaged drugs P may also be seated on the protrusion 172 in at least one case of the case in which the blister-packaged drugs P are dispensed from the drug accommodation unit 110 and then the new blister-packaged drugs P are fed while rotating the drug accommodation unit 110 in the feeding direction Y, the case in which the drug accommodation unit 110 in which the new blister-packaged drugs P are fed passes above the rotation shaft R2 except for the rotation shaft R1 of the at least two rotation shafts R1 and R2 disposed adjacent to the dispensing unit 130, and the case in which the blister-packaged drugs P passes under the at least two rotation shafts R1 and R2.

Thus, the protrusion 172 may reduce the frictional force generated when the blister-packaged drugs P are moved in the state where the blister-packaged drugs P are seated to move the blister-packaged drugs P with minimized noise and vibration.

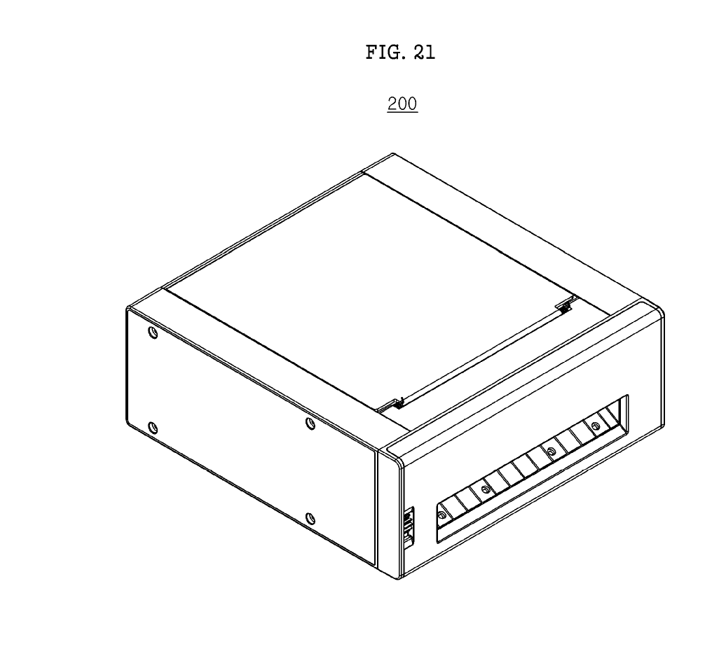

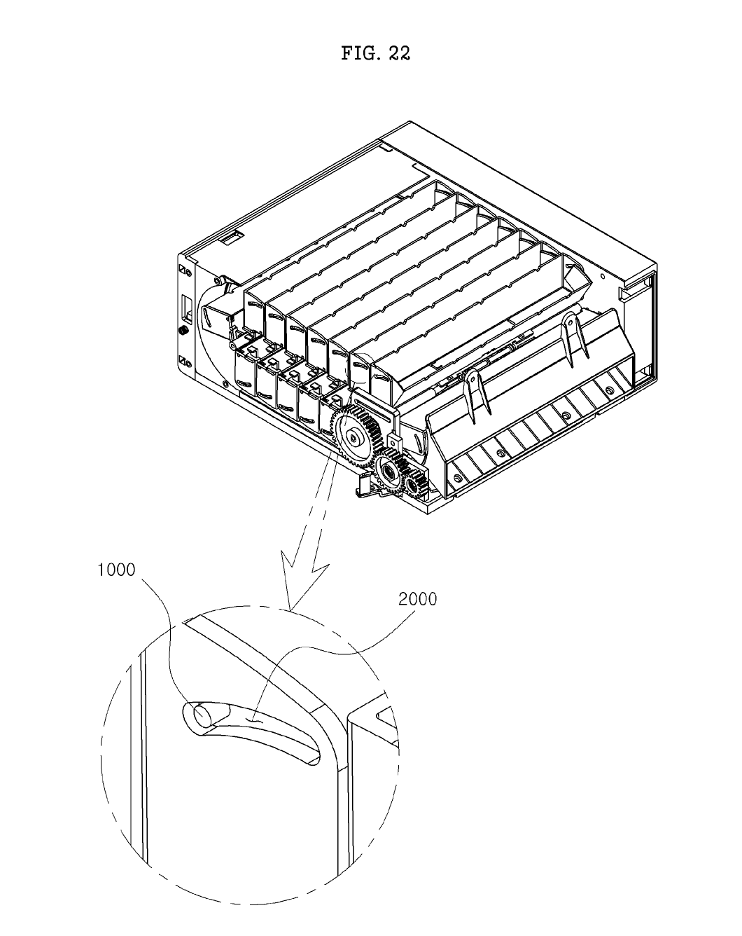

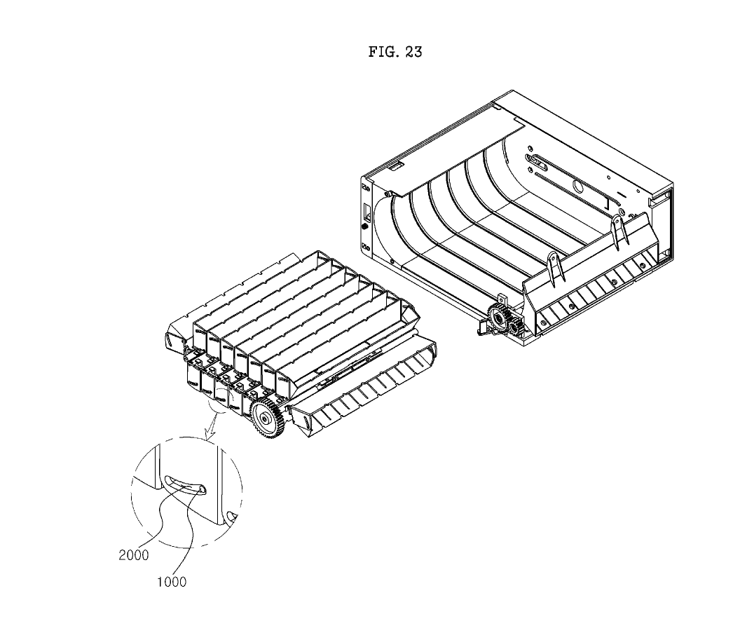

FIG. 21 is a schematic perspective view illustrating a modified example of the box for dispensing blister-packaged drugs according to an embodiment of the present invention, FIG. 22 is a view illustrating a constitution of the modified example of the box for dispensing the blister-packaged drugs according to an embodiment of the present invention, and FIG. 23 is an exploded perspective view illustrating the modified example of the box for dispensing the blister-packaged drugs according to an embodiment of the present invention.

Referring to FIGS. 21 to 23, a box 200 for dispensing blister-packaged drugs may have the same constitution and effect as those of the forgoing embodiment except for a guide hole 2000 defined in a side wall and a guide protrusion 100Q disposed on a rotation wall, and thus descriptions except for the guide hole 2000 and the guide protrusion 1000 will be omitted.

The rotation wall may be rotated by free fall due to the gravity. In this case, the rotating range of the rotation wall may be limited.

That is, since the guide protrusion 1000 disposed on the rotation wall is inserted into the guide hole 2000 defined in the side wall, the range to be rotated by the free fall of the rotation wall may be limited within a range in length of the guide hole 2000.

Although a preferred embodiment of the present invention has been disclosed, various changes and modifications may be made thereto by one skilled in the art without departing from the scope and spirit of the invention as set forth in the appended claims. It is also understood that the terms used herein are merely descriptive, rather than limiting, and that various changes may be made without departing from the scope and spirit of the invention.

That is, although the drug accommodation unit 110 has a rectangular shape on the drawings, the present invention is not limited thereto. For example, the drug accommodation unit 110 may have a trapezoid shape that has a width gradually decreasing toward the position moving unit 120.

Also, the present invention is not limited to the drug accommodation unit symmetrically arranged in the two rows. For example, the drug accommodation units may be alternately disposed or arranged in a plurality of rows greater than the two rows or more.

Also, the driving force for rotating the position moving unit 120 and driving the switching part 133 may be supplied from the driving device such as the internal or external motor of the box 100 or 200 for dispensing the blister-packaged drugs.

Also, the rotation members 119a and 119b for rotating the rotatable wall 111 may be limited to the torsion or coil spring. That is, any component that is capable of providing the restoring force by the elastic deformation may be applied to the present invention.

According to the box for dispensing the blister-packaged drugs, the blister-packaged drugs may be dispensed according to the patient's medical prescription to improve accuracy in drug dispensing and work efficiency.

Also, since the blister-packaged drugs are simply dispensed through the movement of the drug accommodation unit, the box for dispensing the blister-packaged drugs may have a simple structure.

Also, when the blister-packaged drugs are fed, it may prevent the blister-packaged drugs from being hooked with the other components to accurately feed the blister-packaged drugs into the drug accommodation unit.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A box for dispensing blister-packaged drugs, the box comprising:
a drug accommodation unit having an accommodation space in which the plurality of blister-packaged drugs are separately accommodated, the drug accommodation unit being disposed in at least one row;
a position moving unit coupled to the drug accommodation unit to move a position of the drug accommodation unit; and
a dispensing unit disposed in the movement direction of the drug accommodation unit to dispense the blister-packaged drugs accommodated in the drug accommodation unit one by one to the outside.

2. The box of claim 1, wherein the drug accommodation unit is disposed in at least two rows, and the drug accommodation units are symmetrically disposed with respect to a boundary of each of the rows in the rows adjacent to each other to dispense the blister-packaged drugs into the dispensing unit at the same time.

3. The box of claim 2, wherein the dispensing unit comprises a storage part temporally storing the blister-packaged drugs dispensed at the same time from the drug accommodation units constituting the at least two rows and a switching part dispensing the blister-packaged drugs one by one from the storage part to the outside.

4. The box of claim 3, wherein the dispensing unit corresponds to the drug accommodation unit constituting each row, and
the switching part blocks the storage part except for the storage part corresponding the drug accommodation unit constituting one row from the outside.

5. The box of claim 4, wherein, when the blister-packaged drugs are dispensed to the outside from the storage part that is not blocked, the switching part allows one of the blocked storage parts to communicate with the outside.

6. The box of claim 3, further comprising a switching power supply part supplying power for switching the switching part.

7. The box of claim 6, wherein the switching part is switchable in a vertical direction by the power supplied from the switching power supply part.

8. The box of claim 7, further comprising a dispensing power supply part supplying power for moving the position of the drug accommodation unit by the position moving unit,
wherein the power supplied from the dispensing power supply part and the power supplied from the switching power supply part are different from each other.

9. The box of claim 1, wherein the drug accommodation unit comprises a rotatable wall partitioning the accommodation space and rotatable to dispense the blister-packaged drugs.

10. The box of claim 9, wherein the rotatable wall is rotated about a rotation shaft by the gravity due to a weight thereof or restoring force due to elastic deformation of a rotation member mounted on the rotation shaft.

11. The box of claim 9, wherein the position moving unit comprises at least two rotation shafts and a rail part wound around the at least two rotation shafts to orbitally change the position of the drug accommodation unit by the rotation of the at least two rotation shafts.

12. The box of claim 11, wherein the blister-packaged drugs are dispensed by the rotation of the rotatable wall while passing above one of the at least two rotation shafts.

13. The box of claim 11, wherein the drug accommodation unit comprises a bottom wall coupled to the rail part and on which the blister-packaged drugs are seated, and
the rotatable wall is rotated by using an edge of a side of the bottom wall as a rotation shaft.

14. The box of claim 13, wherein the bottom wall has a predetermined area spaced apart from the rail part while passing above at least one rotation shaft of the at least two rotation shafts.

15. The box of claim 9, wherein the rotatable wall comprises at least one friction reduction part protruding to reduce frictional force against the blister-packaged drugs when rotated.

16. The box of claim 1, further comprising:
a main body unit providing a predetermined inner space in which the drug accommodation unit is disposed; and
a jam prevention part disposed on a moving path of the drug accommodation unit by the position moving unit to prevent the blister-packaged drugs accommodated in the drug accommodation unit from being jammed between the a partition wall partitioning the drug accommodation unit and the main body unit,
wherein the jam prevention part comprises a protrusion disposed on one of the partition wall and the main body unit and an accommodation part defined in the other one of the partition wall and the main body unit to accommodate the protrusion.

17. The box of claim 16, wherein the jam prevention part has at least one curved portion between the partition wall and the main body unit.

18. The box of claim 16, wherein the position moving unit comprises at least two rotation shafts and a rail part wound around the at least two rotation shafts to orbitally change the position of the drug accommodation unit by the rotation of the at least two rotation shafts,
the partition wall comprises a fixed end coupled to the rail part and an opened end disposed adjacent to the main body unit, and
the accommodation part is recessed from the opened end.

19. The box of claim 16, wherein the protrusion is disposed on the moving path of the drug accommodation unit corresponding to a lower side of the at least two rotation shafts on the inner surface of the main body unit.

20. The box of claim 16, wherein the protrusion is disposed on the moving path of the drug accommodation unit passing above the rotation shaft except for the rotation shaft, on which the blister-packaged drugs pass for dispensing, on the inner surface of the main body unit.
